(19) United States
(12) Patent Application Publication
(10) Pub. No.: US 2008/0136135 A1
(43) Pub. Date: Jun. 12, 2008

(54) TRUCK CAB SUSPENSION VEHICULAR MOUNT

(76) Inventor: James A. Maciak, Erie, PA (US)

Correspondence Address: LORD CORPORATION;PATENT & LEGAL SERVICES, 111 LORD DRIVE, CARY, NC, 27512, US

(21) Appl. No.: 11/858,600

(22) Filed: Sep. 20, 2007

Related U.S. Application Data
(60) Provisional application No. 60/826,301, filed on Sep. 20, 2006.

(51) Int. Cl. B60G 13/04; B21D 53/88

(52) U.S. Cl. 280/124.1; 29/897.2

(57) ABSTRACT

A mount for supporting and isolating a first member from a second member. The mount includes a second member outer mount structure housing, the second member outer housing for attachment with the second member. The mount includes a first member inner mount assembly, the first member inner mount assembly including an at least first member inner mount molded first split, the first member inner mount molded first split including an at least first inclined outwardly facing surface and a first insert core with an expander receiving cavity, the first member inner mount assembly including a first member inner mount molded at least second split, the first member inner mount molded at least second split including a second split inclined outwardly facing surface and a second insert core with an expander receiving cavity. The first member inner mount assembly includes an expander, the expander inserted between the first member inner mount molded first split and the first member inner mount molded second split and received in the first insert core expander receiving cavity and the second insert core expander receiving cavity. The mount includes an at least first elastomeric member, the first elastomeric member bonded to the first inclined outwardly facing surface, and an at least a second split elastomeric member, the second split elastomeric member bonded to the second split inclined outwardly facing surface.

### CROSS REFERENCE

This application claims the benefit of, and incorporates by reference, U.S. Provisional Patent Application No. 60/826,301 filed on Sep. 20, 2006.

### FIELD OF THE INVENTION

The invention relates to the field of suspension mounts. The invention relates to the field of making suspension mounts. More particularly the invention relates to the field of vehicular suspension mounts. More particularly the invention relates to the field of truck cab suspension mounts.

### BACKGROUND OF THE INVENTION

There is a need for cab suspension mounts for supporting truck cab members. There is a need for robust suspension mounts for vehicles. There is a need for an economically feasible method of making cab suspension mounts for supporting truck cab members. There is a need for economic vehicular suspension mounts for isolating and supporting vehicle members.

### SUMMARY OF THE INVENTION

In an embodiment the invention includes a cab suspension mount for supporting and isolating a first member from a second member. The cab suspension mount preferably includes a second member outer mount housing, the second member outer housing for attachment with the second member, the second member outer housing having a first inclined inwardly facing surface, a second inclined inwardly facing surface, a third inclined inwardly facing surface, a fourth inclined inwardly facing surface. The cab suspension mount preferably includes a first member inner mount assembly, the first member inner mount assembly including a first member inner mount molded first split, the first member inner mount molded first split including a first inclined outwardly facing surface and a second inclined outwardly facing surface, and a first insert core with an expander receiving cavity, the first member inner mount assembly including a first member inner mount molded second split, the first member inner mount molded second split including a third inclined outwardly facing surface and a fourth inclined outwardly facing surface, and a second insert core with an expander receiving cavity, the first member inner mount assembly including an expander, the expander inserted between the first member inner mount molded first split and the first member inner mount molded second split and received in the first insert core expander receiving cavity and the second insert core expander receiving cavity. The cab suspension mount preferably includes a first elastomeric member, the first elastomeric member bonded between the first inclined inwardly facing surface and the first inclined outwardly facing surface, a second elastomeric member, the second elastomeric member bonded between the second inclined inwardly facing surface and the second inclined outwardly facing surface, a third elastomeric member, the third elastomeric member bonded between the third inclined inwardly facing surface and the third inclined outwardly facing surface, and a fourth elastomeric member, the fourth elastomeric member bonded between the fourth inclined inwardly facing surface and the fourth inclined outwardly facing surface.

In an embodiment the invention includes a mount for supporting and isolating a first member from a second member. The mount preferably includes a second member outer mount structure housing, the second member outer housing for attachment with the second member. The mount preferably includes a first member inner mount assembly, the first member inner mount assembly including an at least first member inner mount molded first split, the first member inner mount molded first split including an at least first inclined outwardly facing surface and a first insert core with an expander receiving cavity, the first member inner mount assembly including a first member inner mount molded at least second split, the first member inner mount molded at least second split including a second split inclined outwardly facing surface and a second insert core with an expander receiving cavity, the first member inner mount assembly including an expander, the expander inserted between the first member inner mount molded first split and the first member inner mount molded second split and received in the first insert core expander receiving cavity and the second insert core expander receiving cavity. The mount preferably includes an at least first elastomeric member, the first elastomeric member bonded to the first inclined outwardly facing surface, and an at least a second split elastomeric member, the second split elastomeric member bonded to the second split inclined outwardly facing surface.

In an embodiment the invention includes a method of making a mount for supporting and isolating a first member from a second member. The method includes providing a second member outer mount structure housing, the second member outer housing for attachment with the second member. The method includes providing a first member inner mount assembly, the first member inner mount assembly including an at least first member inner mount first split, the first member inner mount first split including an at least first inclined outwardly facing surface, and a first insert core with an expander receiving cavity, the first member inner mount assembly including a first member inner mount at least second split, the first member inner mount at least second split including a second split inclined outwardly facing surface and a second insert core with an expander receiving cavity. The method includes providing a first member inner mount assembly expander. The method includes inserting the expander between the first member inner mount first split and the first member inner mount second split with the expander received in the first insert core expander receiving cavity and the second insert core expander receiving cavity.

It is to be understood that both the foregoing general description and the following detailed description are exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principals and operation of the invention.

### BRIEF DESCRIPTION OF THE DRAWINGS

FIGS. 1A-1C illustrate embodiments of vehicular cab suspension mounts with the suspension mount between a truck cab body and a truck frame body.

FIGS. 2A-2C illustrate embodiments of vehicular engine suspension mounts with the suspension mount between a marine vehicle engine and a vehicle engine mounting frame body.

FIGS. 3A-3B illustrate embodiments of mounts with mount surfaces and features oriented with the mount vertical center axis plane and the horizontal mount midpoint plane.

FIGS. 4A-4I illustrate embodiments of second member outer housings of mounts.

FIGS. 5A-5D illustrate embodiments of first member inner mount assembles with four elastomeric members.

FIGS. 6A-6O illustrate embodiments of first member inner mount molded splits with mold core inserts.

FIG. 7 illustrates an embodiment of a first member inner mount assembly with four elastomeric members.

FIGS. 8A-8I illustrate embodiments of expanders for inserting between the first member inner mount molded first split and second split and received in the first and second insert core expander receiving cavities.

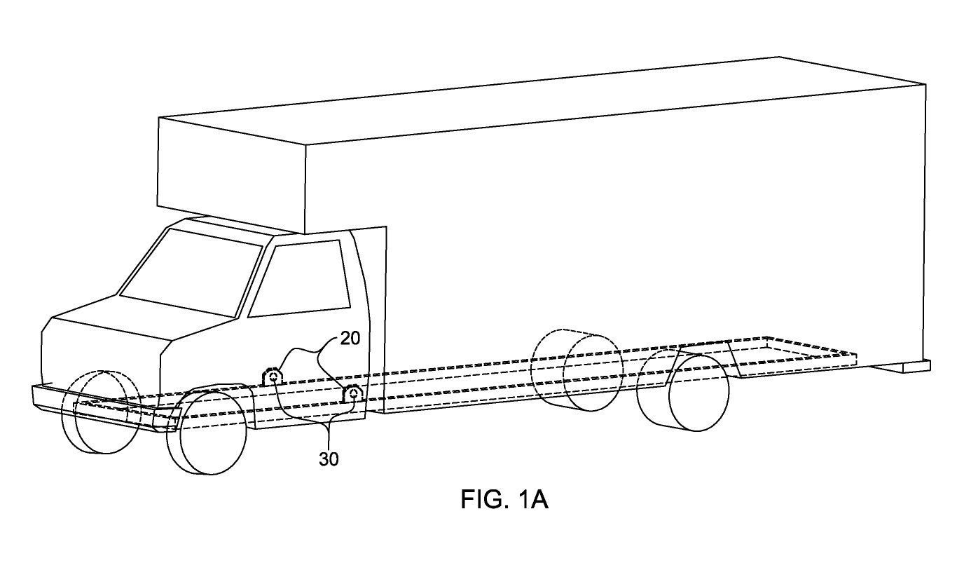

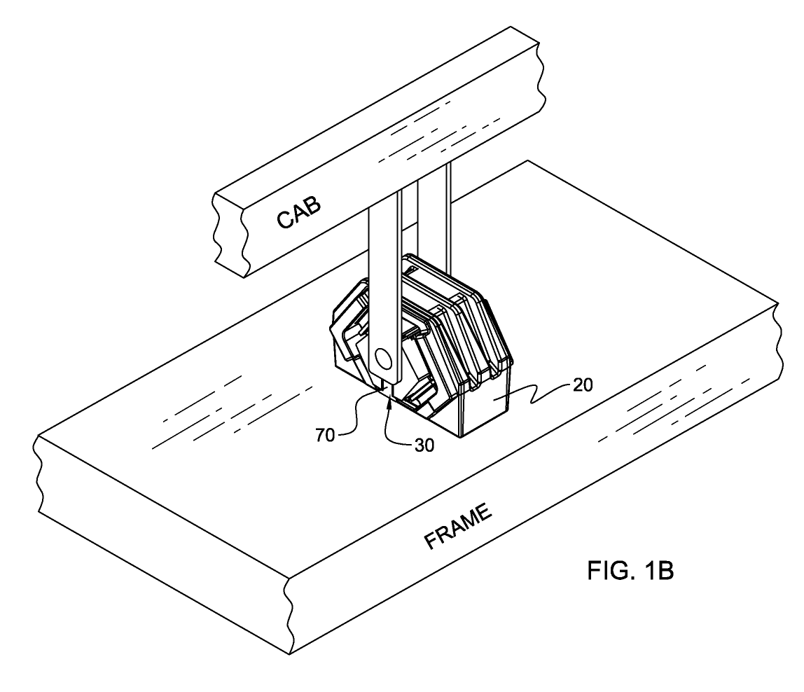

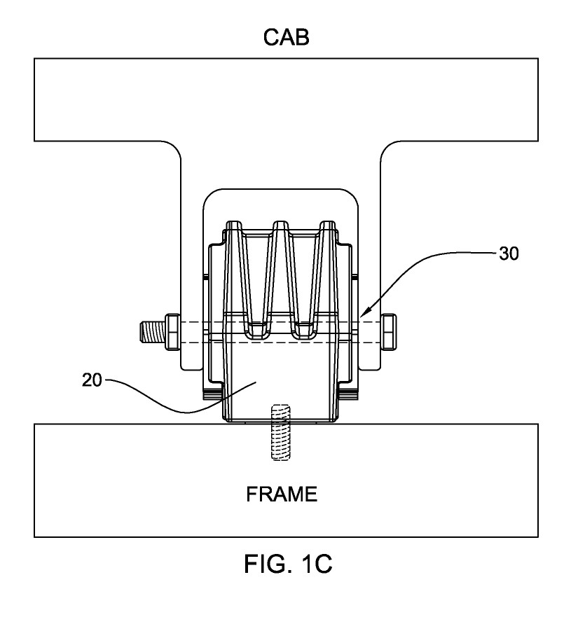

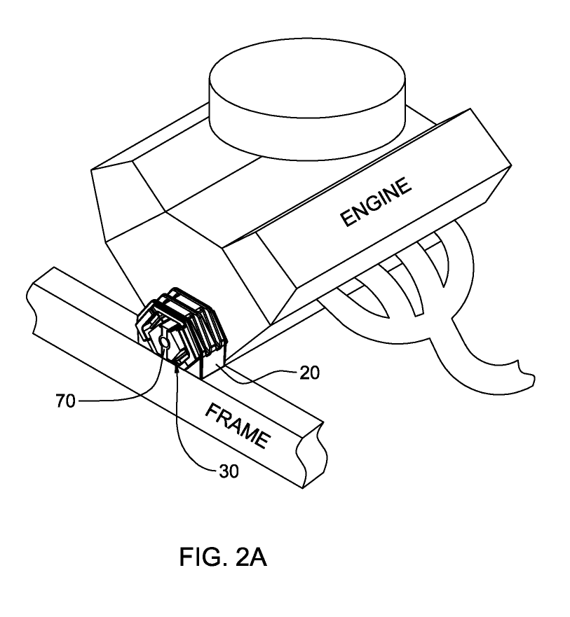

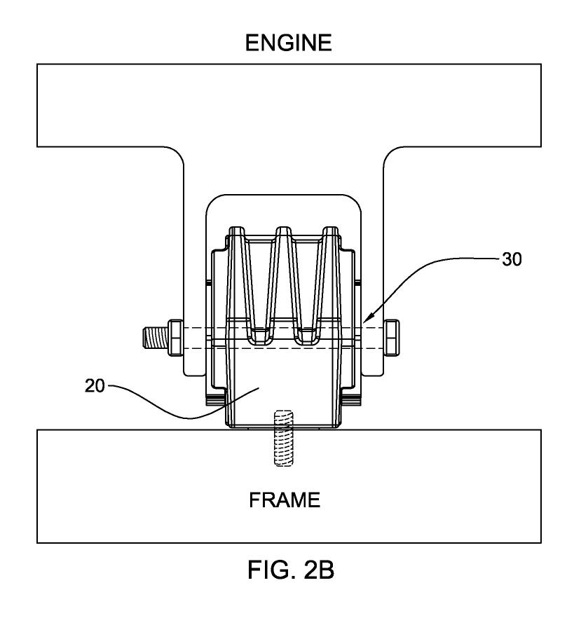

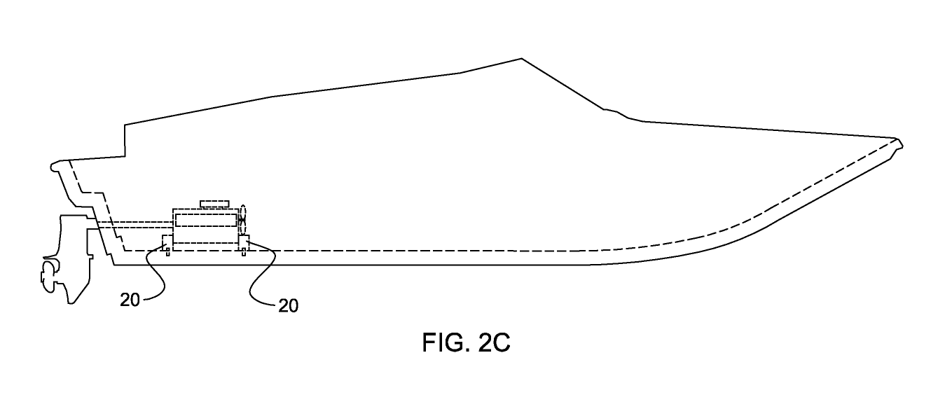

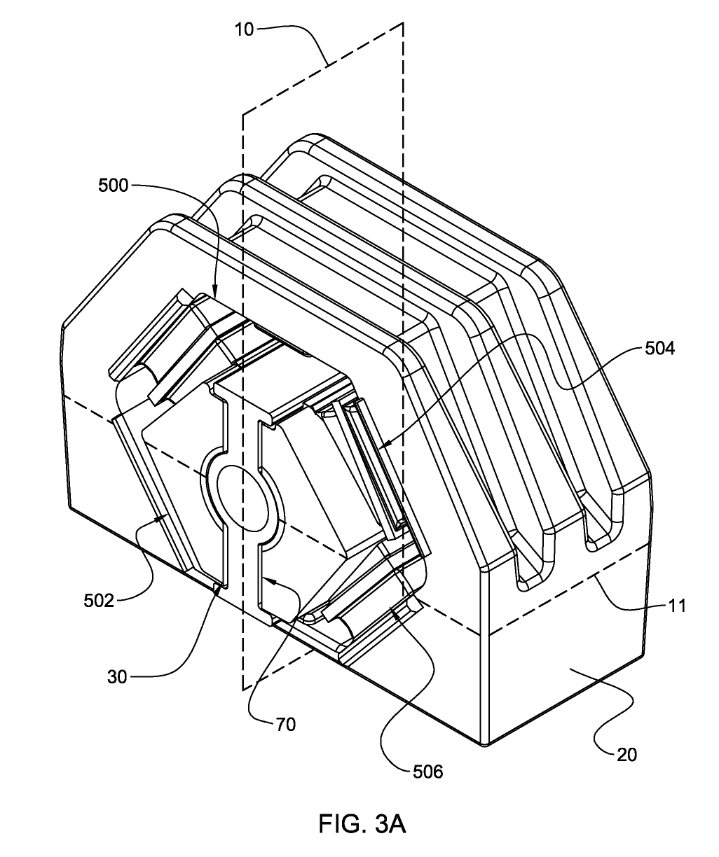

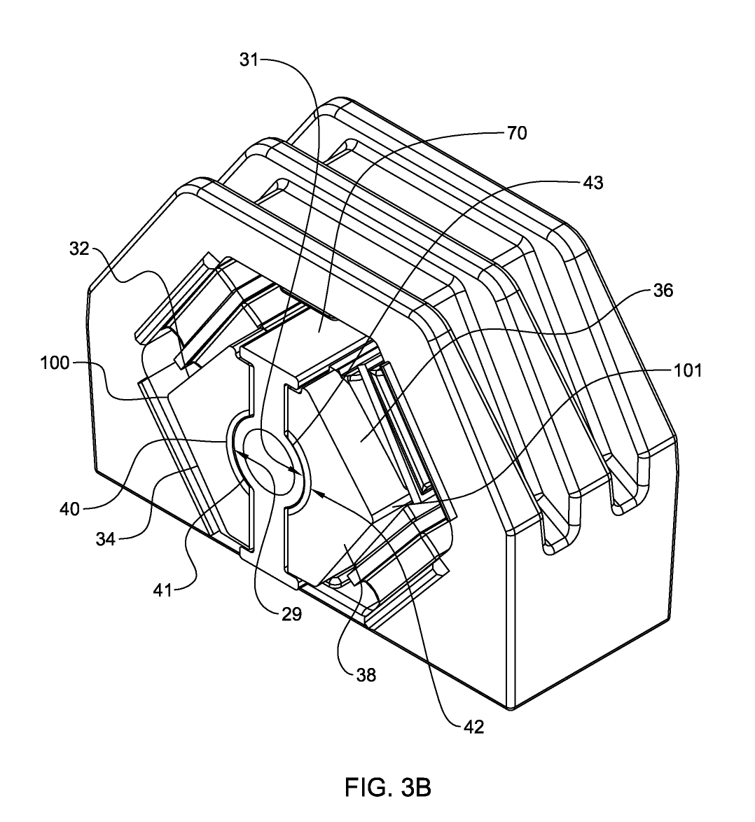

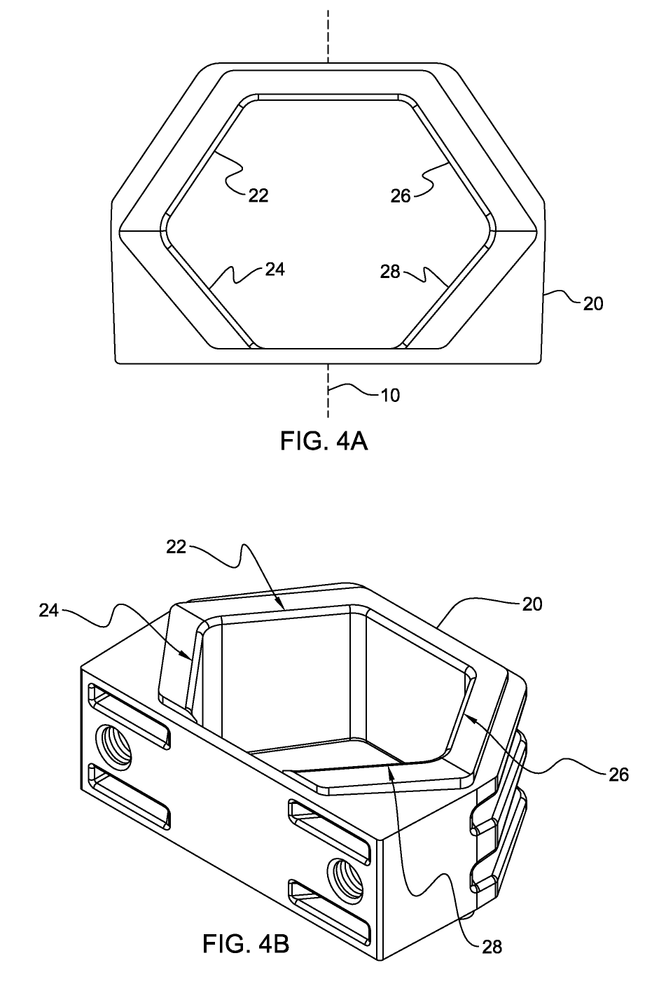

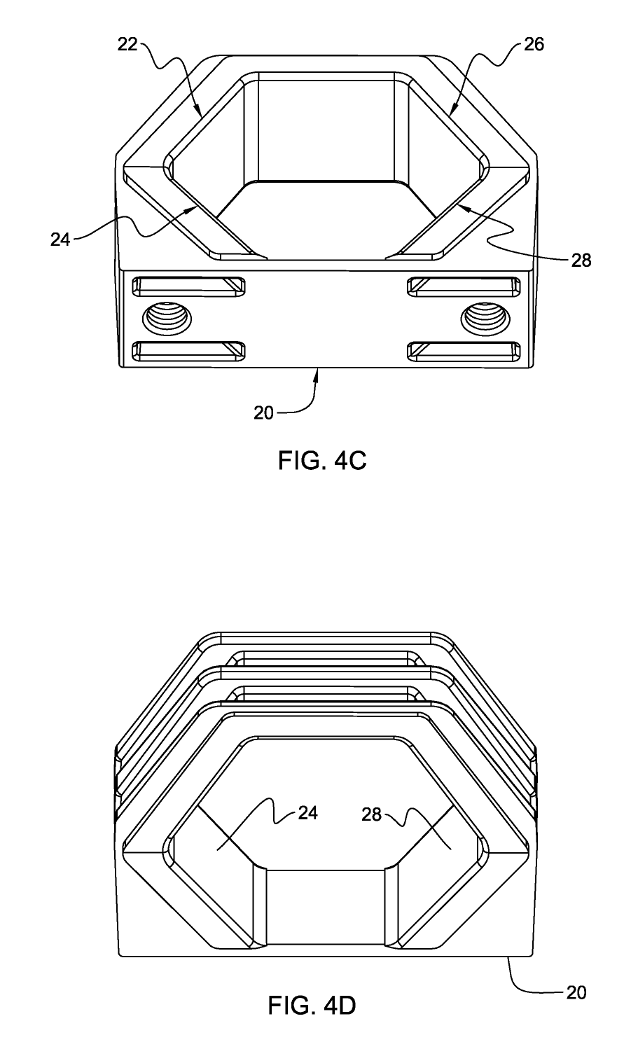

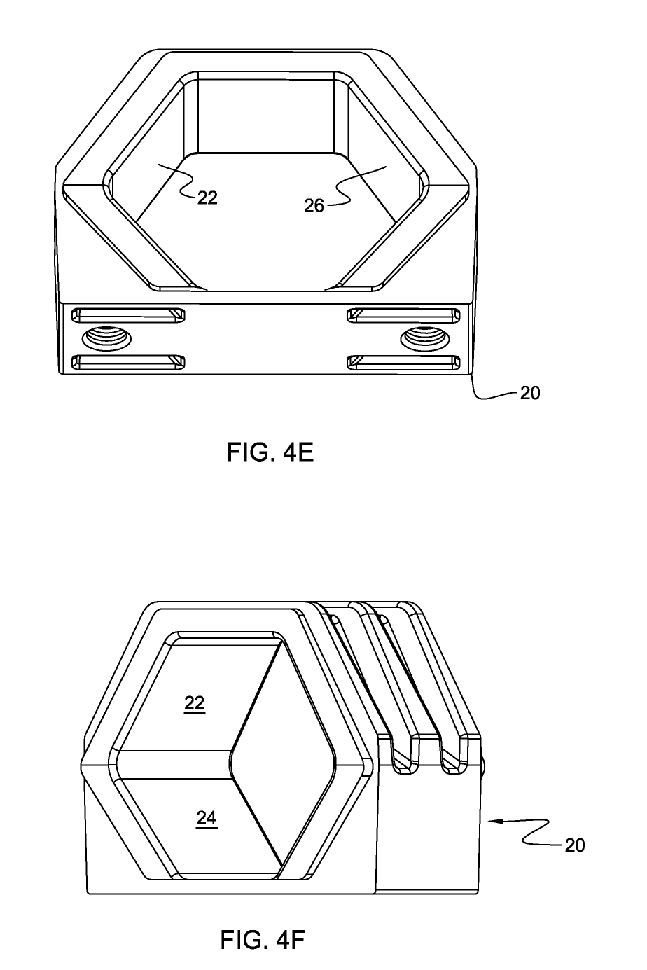

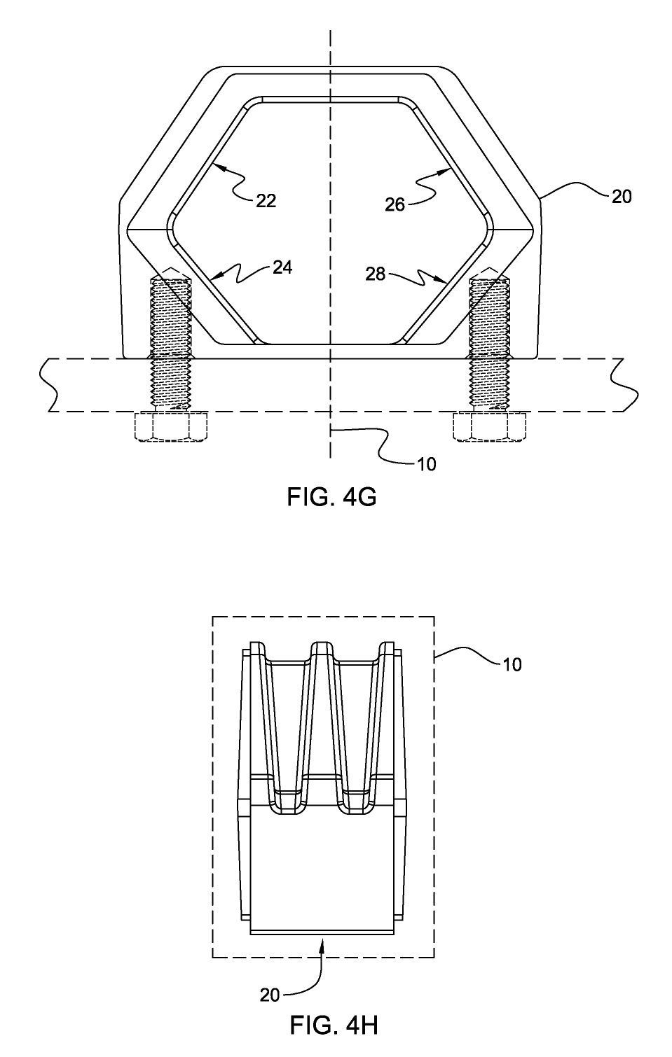

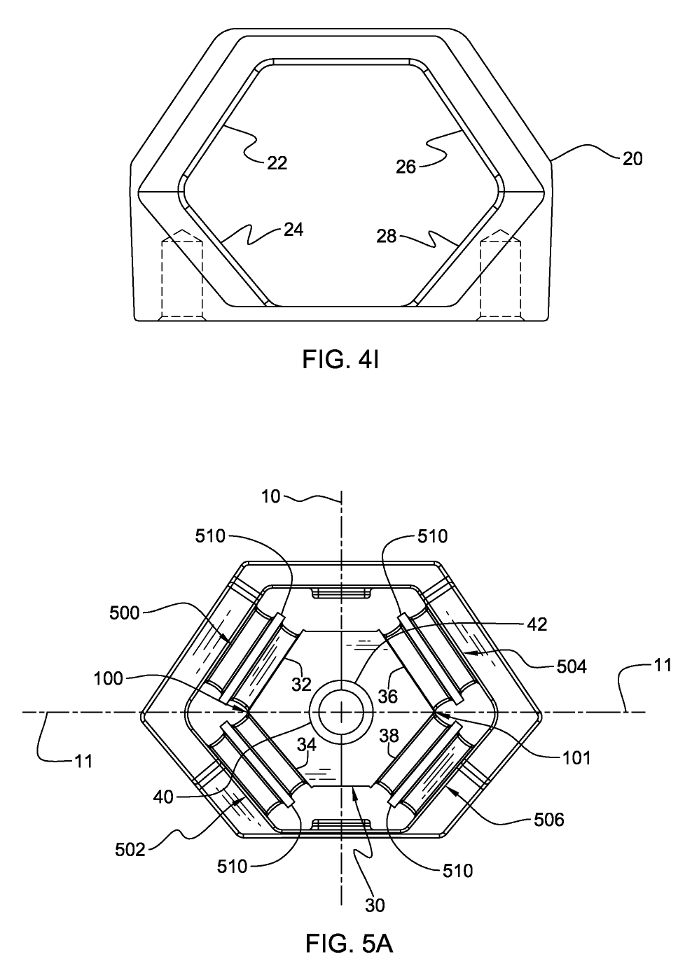

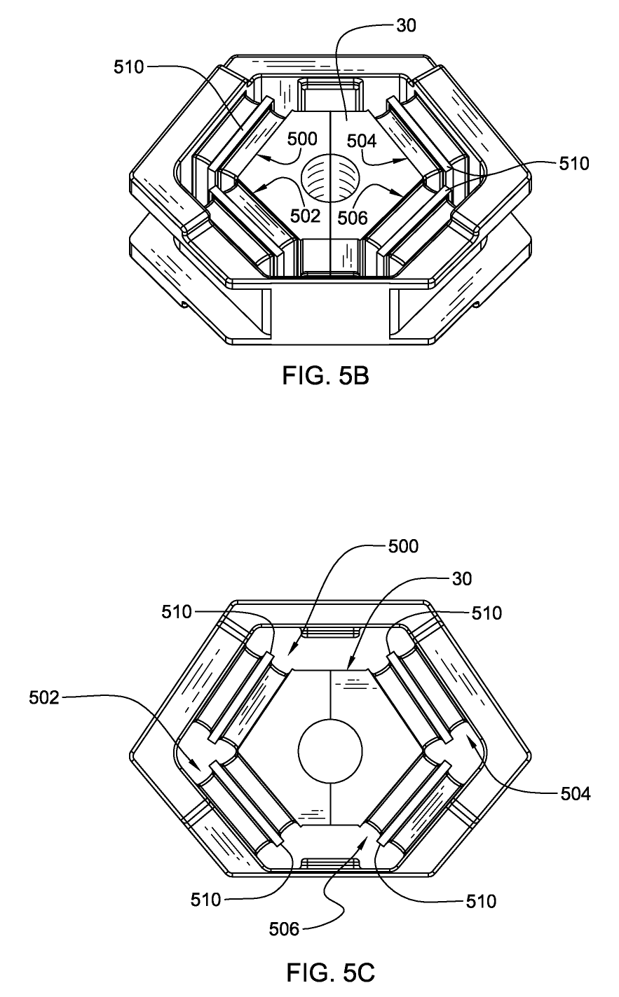

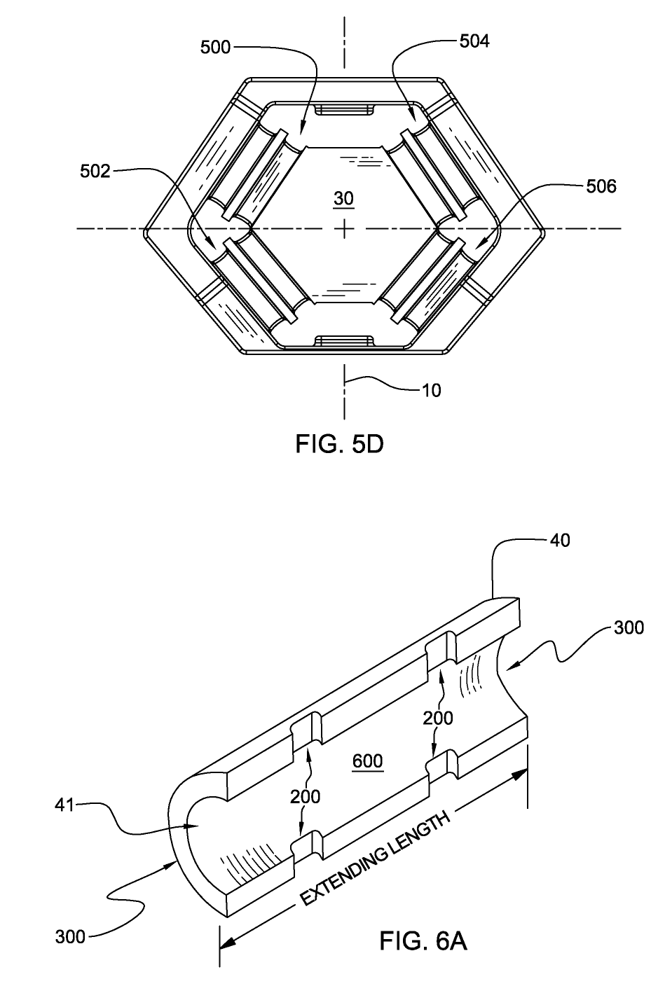

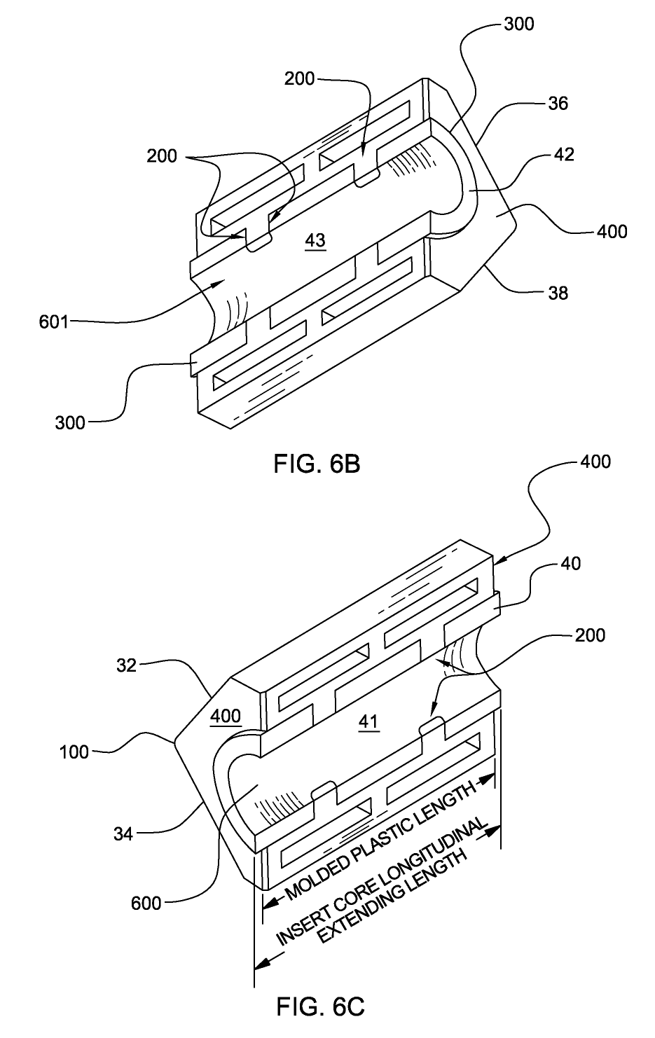

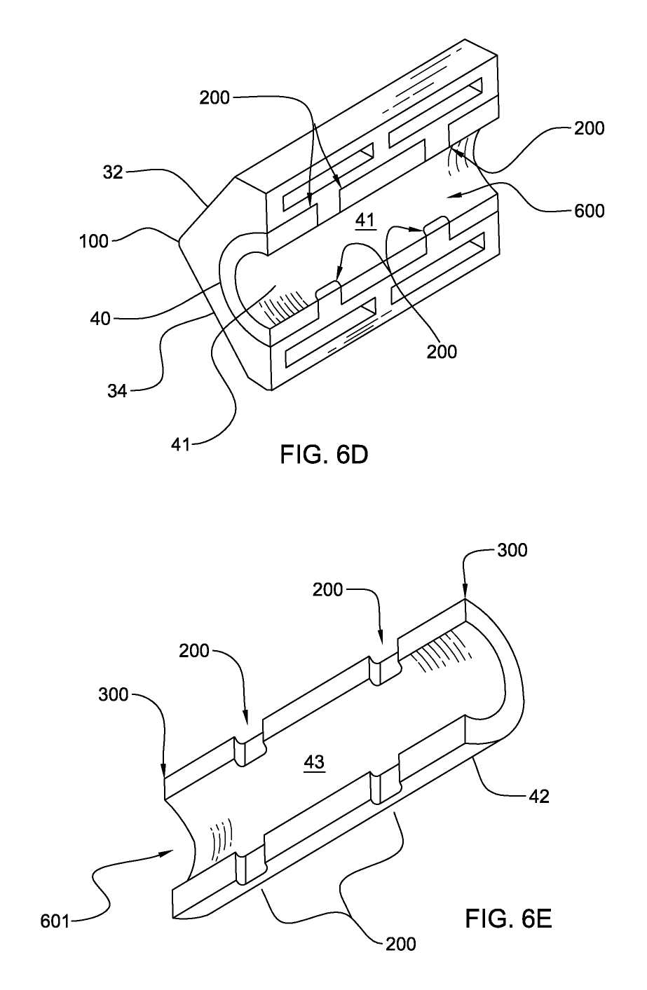

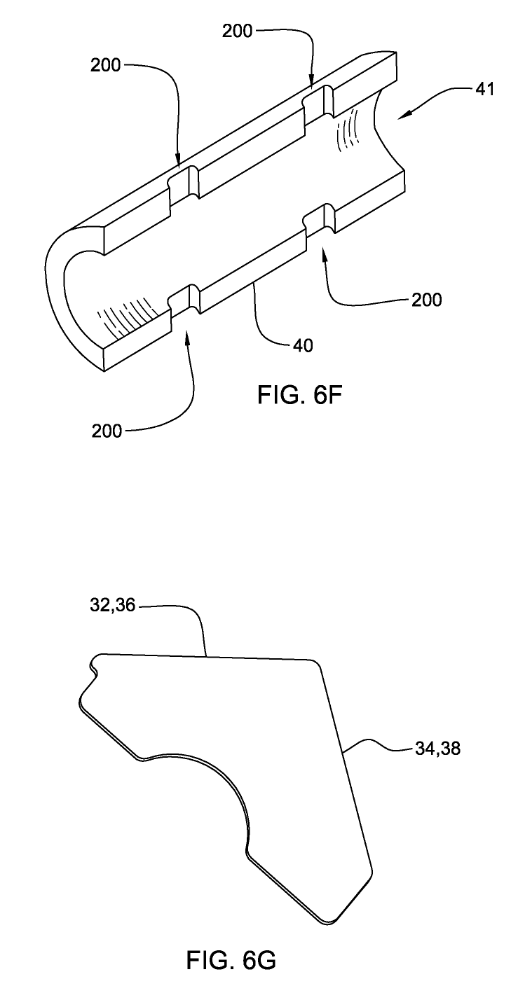

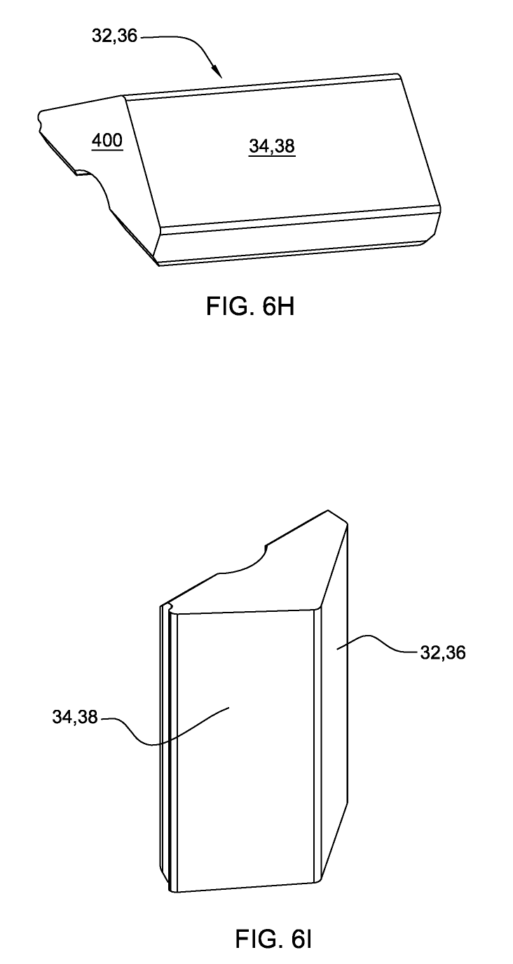

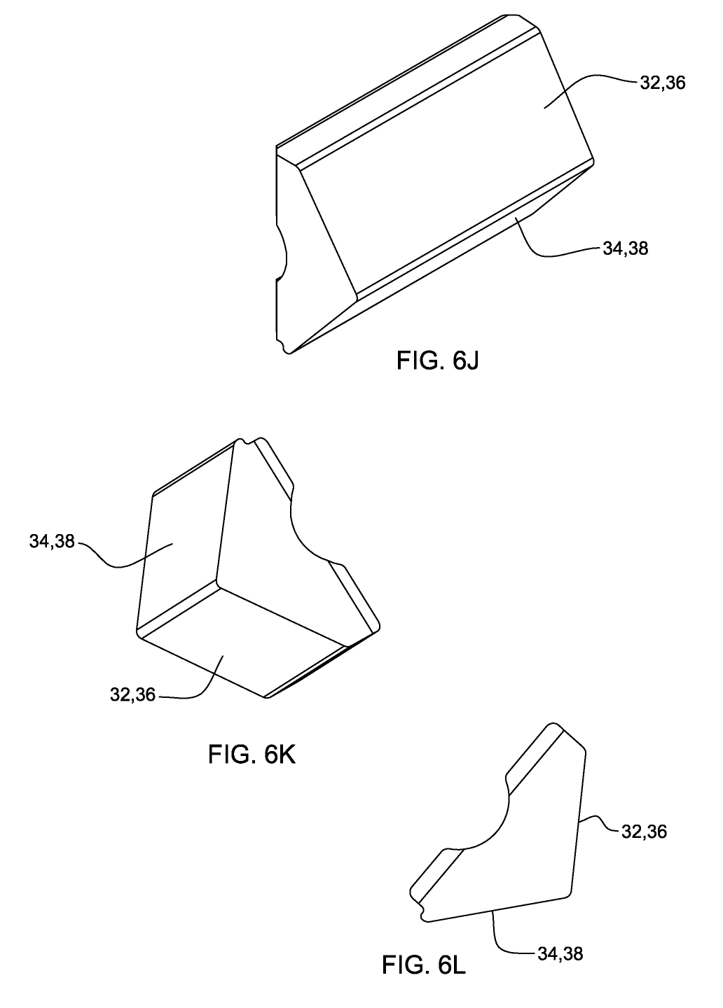

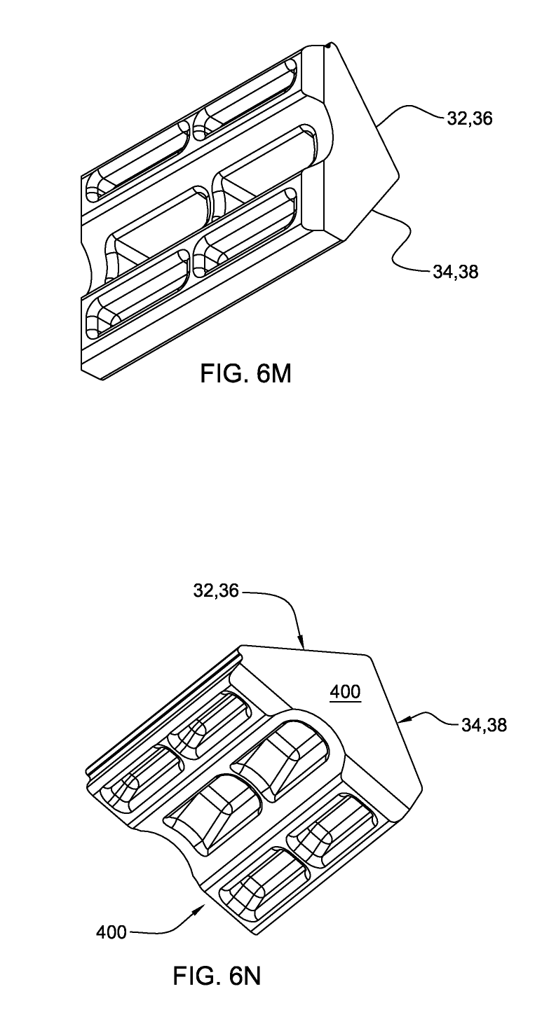

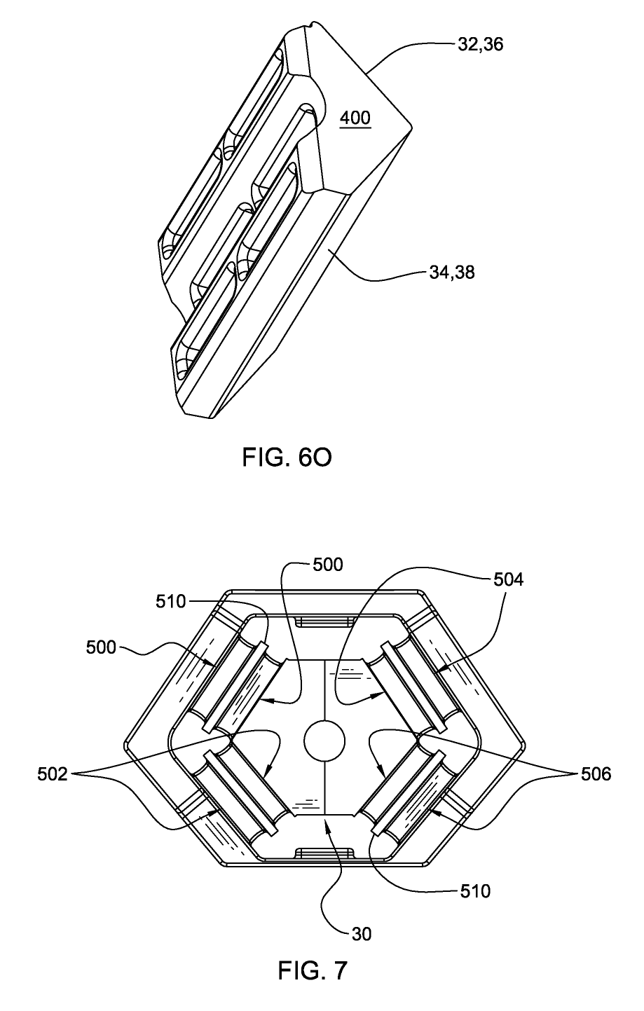

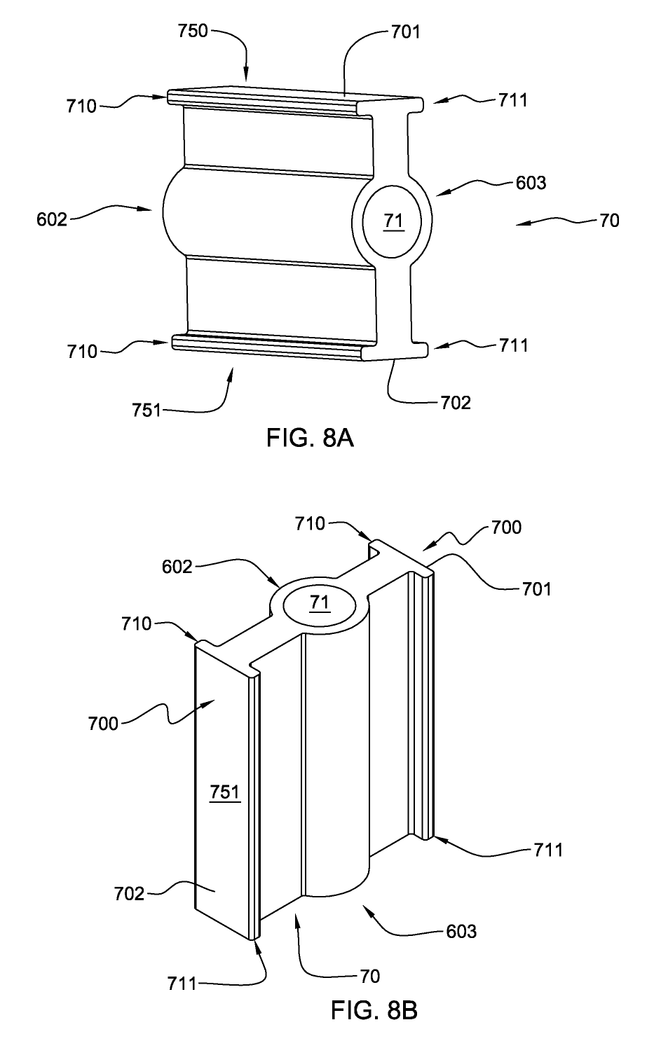

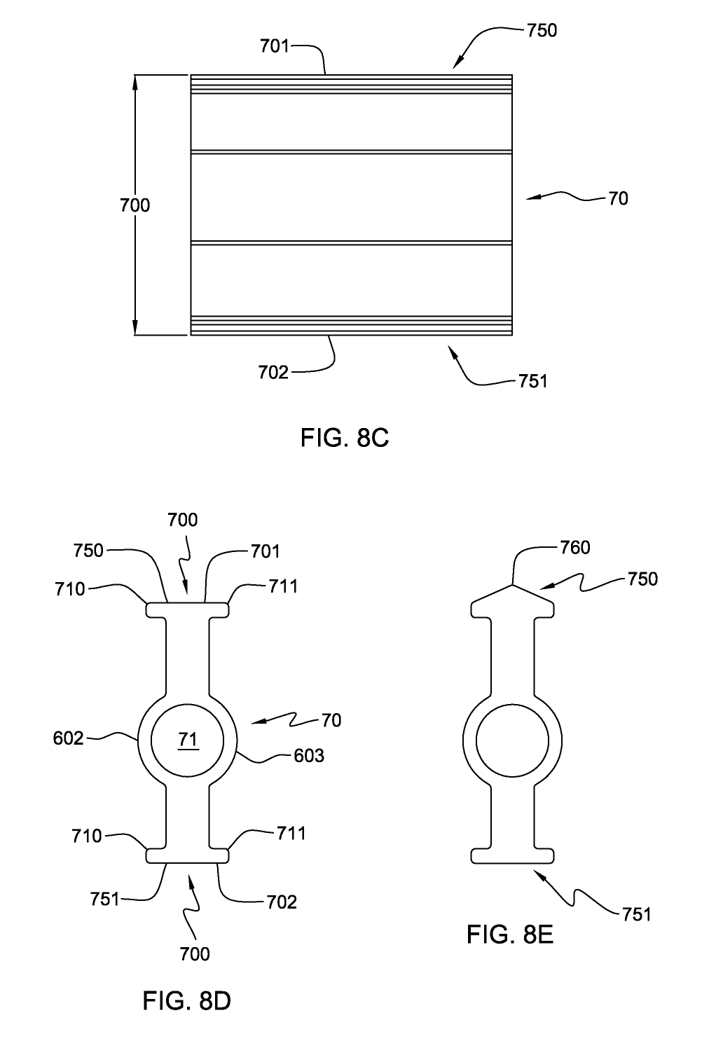

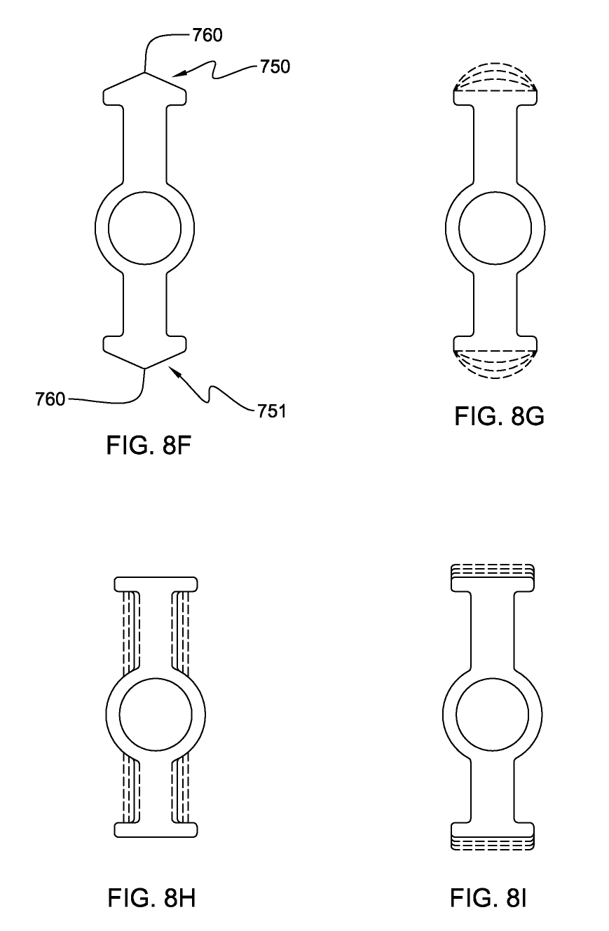

### DETAILED DESCRIPTION OF THE PREFERRED EMBODIMENT

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

Reference will now be made in detail to the present preferred embodiments of the invention, examples of which are illustrated in the accompanying drawings.

In an embodiment the invention includes a cab suspension mount for supporting and isolating a first vehicular member from a second vehicular member. In a preferred embodiment the first member is for attachment to a truck cab body and the second member is for attachment to a truck frame body. The suspension mount includes a second member outer mount housing 20, the second member outer housing 20 for attachment with the second member, preferably the outer housing is comprised of a nonelastomeric substantially rigid structure, preferably a metal structure formed to be connected to the second member from which the first member is to be supported. Preferably the second member outer housing has a first inclined inwardly facing substantially planar surface 22, a second inclined inwardly facing substantially planar surface 24, a third inclined inwardly facing substantially planar surface 26, and a fourth inclined inwardly facing substantially planar surface 28. Preferably the outer housing substantially planar surfaces are oriented relative to the mount vertical center axis plane 10. The mount preferably includes a first member inner mount assembly 30, the first member inner mount assembly 30 including a first member inner mount molded first split 29, the first member inner mount molded first split 29 including a first inclined outwardly facing substantially planar outer perimeter molded surface 32 and a second inclined outwardly facing substantially planar outer perimeter molded surface 34, and a first insert core 40 with an expander receiving cavity 41. Preferably the first inclined outwardly facing surface 32 is an upper surface and the second inclined outwardly facing surface 34 is a lower surface preferably with the upper and lower split surfaces oriented relative to the mount vertical center axis plane 10, and intersecting at a first mount midpoint 100 distal from the vertical center axis plane 10, and distal from an expander and the insert core 40. Preferably the mold core insert 40 is inserted into a plastic injection mold with the first and second surfaces molded to it, preferably with the mold core insert 40 comprised of a nonelastomeric metal insert core with the first and second plastic surfaces 32,34 molded to it. Preferably the mold insert core 40 is nonplastic, preferably metal, preferably with molding interlockers 200, preferably interlocking tab/indent physical keystones locking the core and surrounding molded plastic. Preferably the insert core 40 has a longitudinal extending length, preferably longer than longitudinal extending length of the surrounding molded plastic forming the outward faces, preferably with insert core ends 300 extending and protruding out from the surrounding plastic and inclined surfaces ends 400. Preferably the first member inner mount assembly 30 including a first member inner mount molded second split 31, the first member inner mount molded second split 31 including a third inclined outwardly facing substantially planar outer perimeter molded surface 36 and a fourth inclined outwardly facing substantially planar outer perimeter molded surface 38. Preferably the third and fourth surfaces are upper and lower surfaces oriented relative to the mount vertical center axis plane 10, and intersect at a second mount midpoint 101 distal from the vertical center axis plane 10, and distal from an expander and the second split insert core 42. The first member inner mount molded second split 31, preferably includes second insert core 42 with expander receiving cavity 43, preferably with the mold core insert 42 inserted into a plastic injection mold with the third and fourth surfaces 36 and 38 molded to it, preferably a metal insert core 42 with the third and fourth surfaces 36 and 38 molded plastic surfaces, preferably with the insert core ends 300 protruding out beyond the plastic ends 400. Preferably the first member inner mount assembly 30 including an expander 70. The expander 70 inserted between the first member inner mount molded first split 29 and the first member inner mount molded second split 31 and received in the first insert core expander receiving cavity 41 and the second insert core expander receiving cavity 43. The expander 70 preferably having a uniform cross-section relative to insert core longitudinal length, preferably an extruded metal expander 70 with the uniform cross-section relative to the inclined surfaces. Preferably the outwardly facing surfaces are planar, and preferably are noncircular and noncurved. Preferably the inwardly facing surfaces are planar, and preferably are noncircular and noncurved. Preferably the mount includes a first elastomeric member 500, the first elastomeric member bonded between the first inclined inwardly facing surface and the first inclined outwardly facing surface, a second elastomeric member 502, the second elastomeric member 502 bonded between the second inclined inwardly facing surface and the second inclined outwardly facing surface, a third elastomeric member 504, the third elastomeric member 504 bonded between the third inclined inwardly facing surface and the third inclined outwardly facing surface, and a fourth elastomeric member 506, the fourth elastomeric member 506 bonded between the fourth inclined inwardly facing surface and the fourth inclined outwardly facing surface. Preferably the expander 70 includes a junction 71 for attachment with the first member, preferably with the expander junction 71 including a bolt hole or a protruding stud for fixturing with the first member to be isolated and supported from the second member. Preferably the first insert core 40 has a first mating concave circular surface 600 defining the first insert core expander receiving cavity 41 and the second insert core 42 has a second mating concave circular surface 601 defining the second insert core expander receiving cavity 43, with the expander 70 including a first corresponding matching convex circular mating surface 602 contacting the first insert core first mating concave surface and an opposing second corresponding matching convex circular mating surface 603 contacting the second insert core mating concave surface. Preferably the expander junction 71 is centered between the first and second convex mating surfaces. Preferably the expander 70 has a longitudinally extending length 700 with a first expander end 701 and a distal second expander end 702, preferably an upper end 701 and a lower end 702, preferably with the longitudinally extending length 700 in alignment with the mount vertical center axis plane 10. Preferably the expander longitudinally extending length 700 is aligned with a mount vertical center axis plane 10 and the first upper expander end 701 includes a first flange protrusion 710 and an opposing second flange protrusion 711, the first flange protrusion 710 and the second flange protrusion 711 protruding away from the mount vertical center axis plane 10. Preferably the second expander end 702 includes a third flange protrusion 710 and an opposing fourth flange protrusion 711. Preferably the first inclined outwardly facing surface and the third inclined outwardly facing surface converge towards the first upper expander end 701. Preferably the second inclined outwardly facing surface and the fourth inclined outwardly facing surface converge towards the second lower expander end 702. Preferably the expander longitudinally extending length 700 is aligned with a mount vertical center axis plane 10 and the first inclined outwardly facing surface and the second inclined outwardly facing surface converge towards a first mount midpoint 100 distal from the mount vertical center axis plane 10. Preferably the expander longitudinally extending length 700 is aligned with a mount vertical center axis plane 10 and the third inclined outwardly facing surface and the fourth inclined outwardly facing surface converge towards a second mount midpoint 101 distal from the mount vertical center axis plane 10 and distal and opposing the first mount midpoint 100 with the plane 10 centered between the mount midpoints 100 and 101. Preferably the expander longitudinally extending length 700 is aligned with a mount vertical center axis plane 10 and the first inclined outwardly facing surface and the second inclined outwardly facing surface converge towards a first mount midpoint 100 distal from the mount vertical center axis plane, and the third inclined outwardly facing surface and the fourth inclined outwardly facing surface converge towards opposing second mount midpoint 101 distal from the mount vertical center axis plane 10 with the vertical center axis plane centered between the first and second mount midpoints with the first and second mount midpoints defining a horizontal mount midpoint plane 11 preferably normal to the vertical center axis plane 10. Preferably the first elastomeric member 500 includes a first nonelastomeric shim 510 bonded in the elastomer and between the first inclined inwardly facing surface 22 and the first inclined outwardly facing surface 32, preferably with the planar shim 510 in alignment with the planar first inclined inwardly facing surface and the planar first inclined outwardly facing surface. Preferably the second elastomeric member 502 includes a second nonelastomeric shim 510 bonded in the elastomer and between the second inclined inwardly facing surface 24 and the second inclined outwardly facing surface 34, preferably with planar shim 510 in alignment with the planar second inclined inwardly facing surface 502 and the planar second inclined outwardly facing surface 34. Preferably the third elastomeric member 504 includes a third nonelastomeric shim 510 bonded in the elastomer and between the third inclined inwardly facing surface 26 and the third inclined outwardly facing surface 36, preferably with the planar shim 510 in alignment with the planar third inclined inwardly facing surface 26 and the planar third inclined outwardly facing surface 36. Preferably the fourth elastomeric member 506 includes a fourth nonelastomeric shim 510 bonded in the elastomer and between the fourth inclined inwardly facing surface 28 and the fourth inclined outwardly facing surface 38, preferably with the planar shim 510 in alignment with the planar fourth inclined inwardly facing surface and the planar fourth inclined outwardly facing surface. Preferably the first elastomeric member includes a first nonelastomeric shim 510, the second elastomeric member includes a second nonelastomeric shim 510, the third elastomeric member includes a third nonelastomeric shim 510, and the fourth elastomeric member includes a fourth nonelastomeric shim 510, preferably with the nonelastomeric shims substantially planar and bonded in the elastomer between and in parallel alignment with the inclined inwardly facing surfaces and the inclined outwardly facing surfaces. Preferably second member outer mount housing 20 is nonextensible and formed from a metal, preferably with the inner mount molded split members outwardly facing planer surfaces nonextensible and formed from molded plastic with the inner mount molded split member plastic molded partially around the metal insert cores 40, 42, which preferably are nonextensible structures, preferably metal tubular shell segments, preferably a tube half. Preferably the split members are formed with molded glass filled plastic between the metal insert core tube halves and the upper and lower outwardly facing planer surfaces with the mold insert core inserted into a plastic injection mold with glass filled plastic then injection molded to the insert core. Preferably the elastomer is bonded to the mold bonded plastic outwardly facing substantially planer surfaces of the splits, and planar nonextensible shims 510 preferably formed from a metal, with the elastomer bonded to the metal shims inner and outer facing planar surfaces, and with the elastomer bonded to the second member outer mount housing metal inwardly facing planar surfaces. Preferably the expander 70 is inserted after the elastomers are assembled to and bonded to the inwardly and outwardly bonded planar surfaces of the inner member 30 and the outer member 20. Preferably the second member outer housing first inclined inwardly facing surface is planar. Preferably the second member outer housing second inclined inwardly facing surface is planar. Preferably the second member outer housing third inclined inwardly facing surface is planar. Preferably the second member outer housing fourth inclined inwardly facing surface is planar. In an alternative embodiment the second member outer housing first inclined inwardly facing surface is nonplanar. In an alternative embodiment the second member outer housing second inclined inwardly facing surface is nonplanar. In an alternative embodiment the second member outer housing third inclined inwardly facing surface is nonplanar. In an alternative embodiment the second member outer housing fourth inclined inwardly facing surface is nonplanar. Preferably the first member first inclined outwardly facing surface is planar. Preferably the first member second inclined outwardly facing surface is planar. Preferably the first member third inclined outwardly facing surface is planar. Preferably the first member outer fourth inclined outwardly facing surface is planar. In an alternative embodiment the first inclined outwardly facing surface is nonplanar. In an alternative embodiment the second inclined outwardly facing surface is nonplanar. In an alternative embodiment the third inclined outwardly facing surface is nonplanar. In an alternative embodiment the fourth inclined outwardly facing surface is nonplanar. In an embodiment the second member outer housing first inclined inwardly facing surface is comprised of a nonelastomeric nonextensible foot, preferably a plastic or metal foot shim which is fixed to the outer housing structure. In an embodiment the second member outer housing second inclined inwardly facing surface is comprised of a nonelastomeric nonextensible foot. In an embodiment the second member outer housing third inclined inwardly facing surface includes a nonelastomeric nonextensible foot. In an embodiment the second member outer housing fourth inclined inwardly facing surface includes a nonelastomeric nonextensible foot. Preferably the first upper expander end 701 includes a first flange protrusion 710 and an opposing second flange protrusion 711 and an upper contact snubber end surface 750, preferably a planar contact surface. In an alternative embodiment the contact snubber end surface 750 is a nonplanar contact surface preferably with a central peak protrusion 760, preferably with the peak 760 aligned with the central vertical axis 10. Preferably the second lower opposing expander end includes a third flange protrusion and a opposing fourth flange protrusion and a lower contact snubber end surface 751, preferably a planar contact surface. In an alternative embodiment the contact end surface 751 is a nonplanar contact surface preferably with a central peak protrusion 760, preferably with the peak 760 aligned with central vertical axis 10. Preferably the invention includes mounts and methods of making mounts and a system of making mounts with a plurality of expanders 70, preferably with at least first, second, and third expanders 70, with variation in at least one predetermined expander feature dimension, preferably chosen from and including variation in expander end contact longitudinal axis thickness, variation in contact snubber thickness in direction away from center, variation contact snubber surface crossectional shape including planar and nonplanar, peak heights and inclined angles and curvature, and variation in expander thickness oriented with the vertical axis plane 10.

In an embodiment the invention includes a cab suspension mount for supporting and isolating a first member from a second member. In an embodiment the invention includes an engine mount for supporting and isolating a first member from a second member. In an embodiment the invention includes a vehicle engine mount for supporting and isolating a first member from a second member. In an embodiment the invention includes a marine vehicle engine mount for supporting and isolating a first member from a second member. The mount includes the second member outer mount structure for attachment with the second member, preferably formed to be connected to the second member. The mount includes the first member inner mount assembly, the first member inner mount assembly including an at least first member inner mount molded first split, the first member inner mount molded first split including an at least first inclined outwardly facing surface and a first insert core with an expander receiving cavity. The first member inner mount assembly including a first member inner mount molded at least second split, the first member inner mount molded at least second split including a second split inclined outwardly facing surface, and a second insert core with an expander receiving cavity. The first member inner mount assembly including an expander, the expander inserted between the first member inner mount molded first split and the first member inner mount molded second split and received in the first insert core expander receiving cavity and the second insert core expander receiving cavity. The mount includes an at least first elastomeric member, the first elastomeric member bonded to the first inclined outwardly facing surface, and a second split elastomeric member, the second split elastomeric member bonded to the second split inclined outwardly facing surface. Preferably the second member outer housing has a first inclined inwardly facing substantially planar surface 22, a second inclined inwardly facing substantially planar surface 24, a third inclined inwardly facing substantially planar surface 26, and a fourth inclined inwardly facing substantially planar surface 28. Preferably the outer housing substantially planar surfaces are oriented relative to the mount vertical center axis plane 10. The mount preferably includes a first member inner mount assembly 30, the first member inner mount assembly 30 including a first member inner mount molded first split 29, the first member inner mount molded first split 29 including a first inclined outwardly facing substantially planar outer perimeter molded surface 32 and a second inclined outwardly facing substantially planar outer perimeter molded surface 34, and a first insert core 40 with an expander receiving cavity 41. Preferably the first inclined outwardly facing surface 32 is an upper surface and the second inclined outwardly facing surface 34 is a lower surface preferably with the upper and lower split surfaces oriented relative to the mount vertical center axis plane 10, and intersecting at a first mount midpoint 100 distal from the vertical center axis plane 10, and distal from an expander and the insert core 40. Preferably the mold core insert 40 is inserted into a plastic injection mold with the first and second surfaces molded to it, preferably with the mold core insert 40 comprised of a nonelastomeric metal insert core with the first and second plastic surfaces 32,34 molded to it. Preferably the mold insert core 40 is nonplastic, preferably metal, preferably with molding interlockers 200, preferably interlocking tab/indent physical keystones locking the core and surrounding molded plastic. Preferably the insert core 40 has a longitudinal extending length, preferably longer than longitudinal extending length of the surrounding molded plastic forming the outward faces, preferably with insert core ends 300 extending and protruding out from the surrounding plastic and included surfaces ends 400. Preferably the first member inner mount assembly 30 including a first member inner mount molded second split 31, the first member inner mount molded second split 31 including a third inclined outwardly facing substantially planar outer perimeter molded surface 36 and a fourth inclined outwardly facing substantially planar outer perimeter molded surface 38. Preferably the third and fourth surfaces are upper and lower surfaces oriented relative to the mount vertical center axis plane 10, and intersect at a second mount midpoint 101 distal from the vertical center axis plane 10, and distal from an expander and the second split insert core 42. The first member inner mount molded second split 31, preferably includes second insert core 42 with expander receiving cavity 43, preferably with the mold core insert 42 inserted into a plastic injection mold with the third and fourth surfaces 36 and 38 molded to it, preferably a metal insert core 42 with the third and fourth surfaces 36 and 38 molded plastic surfaces, preferably with the insert core ends 300 protruding out beyond the plastic ends 400. Preferably the first member inner mount assembly 30 including an expander 70. The expander 70 inserted between the first member inner mount molded first split 29 and the first member inner mount molded second split 31 and received in the first insert core expander receiving cavity 41 and the second insert core expander receiving cavity 43. The expander 70 preferably having a uniform cross-section relative to insert core longitudinal length, preferably an extruded metal expander 70 with the uniform cross-section relative to the inclined surfaces. Preferably the outwardly facing surfaces are planar, and preferably are noncircular and noncurved. Preferably the inwardly facing surfaces are planar, and preferably are noncircular and noncurved. Preferably the mount includes a first elastomeric member 500, the first elastomeric member bonded between the first inclined inwardly facing surface and the first inclined outwardly facing surface, a second elastomeric member 502, the second elastomeric member 502 bonded between the second inclined inwardly facing surface and the second inclined outwardly facing surface, a third elastomeric member 504, the third elastomeric member 504 bonded between the third inclined inwardly facing surface and the third inclined outwardly facing surface, and a fourth elastomeric member 506, the fourth elastomeric member 506 bonded between the fourth inclined inwardly facing surface and the fourth inclined outwardly facing surface. Preferably the expander 70 includes a junction 71 for attachment with the first member, preferably with the expander junction 71 including a bolt hole or a protruding stud for fixturing with the first member to be isolated and supported from the second member. Preferably the first insert core 40 has a first mating concave circular surface 600 defining the first insert core expander receiving cavity 41 and the second insert core 42 has a second mating concave circular surface 601 defining the second insert core expander receiving cavity 43, with the expander 70 including a first corresponding matching convex circular mating surface 602 contacting the first insert core first mating concave surface and an opposing second corresponding matching convex circular mating surface 603 contacting the second insert core mating concave surface. Preferably the expander junction 71 is centered between the first and second convex mating surfaces. Preferably the expander 70 has a longitudinally extending length 700 with a first expander end 701 and a distal second expander end 702, preferably an upper end 701 and a lower end 702, preferably with the longitudinally extending length 700 in alignment with the mount vertical center axis plane 10. Preferably the expander longitudinally extending length 700 is aligned with a mount vertical center axis plane 10 and the first upper expander end 701 includes a first flange protrusion 710 and an opposing second flange protrusion 711, the first flange protrusion 710 and the second flange protrusion 711 protruding away from the mount vertical center axis plane 10. Preferably the second expander end 702 includes a third flange protrusion 710 and an opposing fourth flange protrusion 711. Preferably the first inclined outwardly facing surface and the third inclined outwardly facing surface converge towards the first upper expander end 701. Preferably the second inclined outwardly facing surface and the fourth inclined outwardly facing surface converge towards the second lower expander end 702. Preferably the expander longitudinally extending length 700 is aligned with a mount vertical center axis plane 10 and the first inclined outwardly facing surface and the second inclined outwardly facing surface converge towards a first mount midpoint 100 distal from the mount vertical center axis plane 10. Preferably the expander longitudinally extending length 700 is aligned with a mount vertical center axis plane 10 and the third inclined outwardly facing surface and the fourth inclined outwardly facing surface converge towards a second mount midpoint 101 distal from the mount vertical center axis plane 10 and distal and opposing the first mount midpoint 100 with the plane 10 centered between the mount midpoints 100 and 101. Preferably the expander longitudinally extending length 700 is aligned with a mount vertical center axis plane 10 and the first inclined outwardly facing surface and the second inclined outwardly facing surface converge towards a first mount midpoint 100 distal from the mount vertical center axis plane, and the third inclined outwardly facing surface and the fourth inclined outwardly facing surface converge towards opposing second mount midpoint 101 distal from the mount vertical center axis plane 10 with the vertical center axis plane centered between the first and second mount midpoints with the first and second mount midpoints defining a horizontal mount midpoint plane 11 preferably normal to the vertical center axis plane 10. Preferably the first elastomeric member 500 includes a first nonelastomeric shim 510 bonded in the elastomer and between the first inclined inwardly facing surface 22 and the first inclined outwardly facing surface 32, preferably with the planar shim 510 in alignment with the planar first inclined inwardly facing surface and the planar first inclined outwardly facing surface. Preferably the second elastomeric member 502 includes a second nonelastomeric shim 510 bonded in the elastomer and between the second inclined inwardly facing surface 24 and the second inclined outwardly facing surface 34, preferably with planar shim 510 in alignment with the planar second inclined inwardly facing surface 502 and the planar second inclined outwardly facing surface 34. Preferably the third elastomeric member 504 includes a third nonelastomeric shim 510 bonded in the elastomer and between the third inclined inwardly facing surface 26 and the third inclined outwardly facing surface 36, preferably with the planar shim 510 in alignment with the planar third inclined inwardly facing surface 26 and the planar third inclined outwardly facing surface 36. Preferably the fourth elastomeric member 506 includes a fourth nonelastomeric shim 510 bonded in the elastomer and between the fourth inclined inwardly facing surface 28 and the fourth inclined outwardly facing surface 38, preferably with the planar shim 510 in alignment with the planar fourth inclined inwardly facing surface and the planar fourth inclined outwardly facing surface. Preferably the first elastomeric member includes a first nonelastomeric shim 510, the second elastomeric member includes a second nonelastomeric shim 510, the third elastomeric member includes a third nonelastomeric shim 510, and the fourth elastomeric member includes a fourth nonelastomeric shim 510, preferably with the nonelastomeric shims substantially planar and bonded in the elastomer between and in parallel alignment with the inclined inwardly facing surfaces and the inclined outwardly facing surfaces. Preferably second member outer mount housing 20 is nonextensible and formed from a metal, preferably with the inner mount molded split members outwardly facing planer surfaces nonextensible and formed from molded plastic with the inner mount molded split member plastic molded partially around the metal insert cores 40, 42, which preferably are nonextensible structures, preferably metal tubular shell segments, preferably a tube half. Preferably the split members are formed with molded glass filled plastic between the metal insert core tube halfs and the upper and lower outwardly facing planer surfaces with the mold insert core inserted into a plastic injection mold with glass filled plastic then injection molded to the insert core. Preferably the elastomer is bonded to the mold bonded plastic outwardly facing substantially planer surfaces of the splits, and planar nonextensible shims 510 preferably formed from a metal, with the elastomer bonded to the metal shims inner and outer facing planar surfaces, and with the elastomer bonded to the second member outer mount housing metal inwardly facing planar surfaces. Preferably the expander 70 is inserted after the elastomers are assembled to and bonded to the inwardly and outwardly bonded planar surfaces of the inner member 30 and the outer member 20. Preferably the second member outer housing first inclined inwardly facing surface is planar. Preferably the second member outer housing second inclined inwardly facing surface is planar. Preferably the second member outer housing third inclined inwardly facing surface is planar. Preferably the second member outer housing fourth inclined inwardly facing surface is planar. In an alternative embodiment the second member outer housing first inclined inwardly facing surface is nonplanar. In an alternative embodiment the second member outer housing second inclined inwardly facing surface is nonplanar. In an alternative embodiment the second member outer housing third inclined inwardly facing surface is nonplanar. In an alternative embodiment the second member outer housing fourth inclined inwardly facing surface is nonplanar. Preferably the first member first inclined outwardly facing surface is planar. Preferably the first member second inclined outwardly facing surface is planar. Preferably the first member third inclined outwardly facing surface is planar. Preferably the first member outer fourth inclined outwardly facing surface is planar. In an alternative embodiment the first inclined outwardly facing surface is nonplanar. In an alternative embodiment the second inclined outwardly facing surface is nonplanar. In an alternative embodiment the third inclined outwardly facing surface is nonplanar. In an alternative embodiment the fourth inclined outwardly facing surface is nonplanar. In an embodiment the second member outer housing first inclined inwardly facing surface is comprised of a nonelastomeric nonextensible foot, preferably a plastic or metal foot shim which is fixed to the outer housing structure. In an embodiment the second member outer housing second inclined inwardly facing surface is comprised of a nonelastomeric nonextensible foot. In an embodiment the second member outer housing third inclined inwardly facing surface includes a nonelastomeric nonextensible foot. In an embodiment the second member outer housing fourth inclined inwardly facing surface includes a nonelastomeric nonextensible foot. Preferably the first upper expander end 701 includes a first flange protrusion 710 and an opposing second flange protrusion 711 and an upper contact snubber end surface 750, preferably a planar contact surface. In an alternative embodiment the contact snubber end surface 750 is a nonplanar contact surface preferably with a central peak protrusion 760, preferably with the peak 760 aligned with the central vertical axis 10. Preferably the second lower opposing expander end includes a third flange protrusion and a opposing fourth flange protrusion and a lower contact snubber end surface 751, preferably a planar contact surface. In an alternative embodiment the contact end surface 751 is a nonplanar contact surface preferably with a central peak protrusion 760, preferably with the peak 760 aligned with central vertical axis 10. Preferably the invention includes mounts and methods of making mounts and a system of making mounts with a plurality of expanders 70, preferably with at least first, second, and third expanders 70, with variation in at least one predetermined expander feature dimension, preferably chosen from and including variation in expander end contact longitudinal axis thickness, variation in contact snubber thickness in direction away from center, variation contact snubber surface crossectional shape including planar and nonplanar, peak heights and inclined angles and curvature, and variation in expander thickness oriented with the vertical axis plane 10.

In an embodiment the invention includes a method of making a mount for supporting and isolating a first member from a second member. The method includes providing a second member outer mount structure, the second member outer housing for attachment with the second member, preferably formed to be connected to the second member. Preferably the second member outer housing has a first inclined inwardly facing substantially planar surface, a second inclined inwardly facing substantially planar surface, a third inclined inwardly facing substantially planar surface, and a fourth inclined inwardly facing substantially planar surface. Preferably the substantially planar surfaces are oriented relative to a mount vertical center axis plane. The method includes providing a first member inner mount assembly, the first member inner mount assembly including an at least first member inner mount molded first split, the first member inner mount molded first split including an at least first inclined outwardly facing substantially planar outer perimeter molded surface and a second inclined outwardly facing substantially planar outer perimeter molded surface. The provided first member inner mount assembly preferably including a first insert core with an expander receiving cavity, preferably a mold core insert that is inserted into the mold with the first and second surfaces molded to it, preferably a metal insert core with the first and second surfaces plastic, preferably with the mold insert core nonplastic, preferably formed from a metal and having molding interlockers, preferably interlocking tabs/indents for physical keystone locking between core and surrounding molded plastic. Preferably the insert core has a longitudinal extending length, which is preferably longer than the longitudinal extending length of the surrounding molded plastic, prefer with insert core ends extending/protruding out from the surrounding plastic and inclined surfaces. Preferably the provided first member inner mount assembly includes a first member inner mount molded at least second split, the first member inner mount molded at least second split including a second split inclined outwardly facing substantially planar outer perimeter molded surface and a second insert core with an expander receiving cavity. The method includes providing a first member inner mount assembly expander and inserting the expander between the first member inner mount molded first split and the first member inner mount molded second split with the expander received in the first insert core expander receiving cavity and the second insert core expander receiving cavity. Preferably the expander has a uniform cross-section relative to the insert core longitudinal length and the inclined surfaces, preferably with the outwardly facing surfaces noncircular noncurved planar, with the inserted expander urging the inclined outwardly facing substantially planar outer perimeter molded surfaces outward towards the second member outer mount structure. Preferably the method includes providing an at least first elastomeric member between the inner and outer members, preferably the first elastomeric member bonded to the first inclined outwardly facing surface, a second elastomeric member, the second elastomeric member bonded between the second inclined inwardly facing surface and the second inclined outwardly facing surface, a second split elastomeric member, the second split elastomeric member bonded to the second split inclined outwardly facing surface, and a fourth elastomeric member, the fourth elastomeric member bonded between the fourth inclined inwardly facing surface and the fourth inclined outwardly facing surface. Preferably providing a first member inner mount assembly includes molding the at least first inclined outwardly facing substantially planar outer perimeter molded surface to the first insert core, preferably with the mold core insert inserted into the mold with the first and second surfaces plastic molded to it, preferably a metal insert core with the first and second surfaces plastic, preferably mold insert core is nonplastic with molding interlockers, preferably interlocking tabs/indents for physical keystone locking between core and surrounding molded plastic. Preferably the insert core has a longitudinal extending length, prefer longer than longitudinal extending length of the surrounding molded plastic, prefer with insert core ends extending/protruding out from the surrounding plastic and inclined surfaces. Preferably the method includes providing at least a first expander with a first predetermined expander dimensional feature and providing a second expander with a second predetermined expander dimensional feature, with the first predetermined expander dimensional feature different than the second. the first member inner mount assembly including an at least first member inner mount molded first split, the first member inner mount molded first split including an at least first inclined outwardly facing surface and a first insert core with an expander receiving cavity. The first member inner mount assembly including a first member inner mount molded at least second split, the first member inner mount molded at least second split including a second split inclined outwardly facing surface, and a second insert core with an expander receiving cavity. The first member inner mount assembly including an expander, the expander inserted between the first member inner mount molded first split and the first member inner mount molded second split and received in the first insert core expander receiving cavity and the second insert core expander receiving cavity. The mount includes an at least first elastomeric member, the first elastomeric member bonded to the first inclined outwardly facing surface, and a second split elastomeric member, the second split elastomeric member bonded to the second split inclined outwardly facing surface. Preferably the second member outer housing has a first inclined inwardly facing substantially planar surface 22, a second inclined inwardly facing substantially planar surface 24, a third inclined inwardly facing substantially planar surface 26, and a fourth inclined inwardly facing substantially planar surface 28. Preferably the outer housing substantially planar surfaces are oriented relative to the mount vertical center axis plane 10. The mount preferably includes a first member inner mount assembly 30, the first member inner mount assembly 30 including a first member inner mount molded first split 29, the first member inner mount molded first split 29 including a first inclined outwardly facing substantially planar outer perimeter molded surface 32 and a second inclined outwardly facing substantially planar outer perimeter molded surface 34, and a first insert core 40 with an expander receiving cavity 41. Preferably the first inclined outwardly facing surface 32 is an upper surface and the second inclined outwardly facing surface 34 is a lower surface preferably with the upper and lower split surfaces oriented relative to the mount vertical center axis plane 10, and intersecting at a first mount midpoint 100 distal from the vertical center axis plane 10, and distal from an expander and the insert core 40. Preferably the mold core insert 40 is inserted into a plastic injection mold with the first and second surfaces molded to it, preferably with the mold core insert 40 comprised of a nonelastomeric metal insert core with the first and second plastic surfaces 32,34 molded to it. Preferably the mold insert core 40 is nonplastic, preferably metal, preferably with molding interlockers 200, preferably interlocking tab/indent physical keystones locking the core and surrounding molded plastic. Preferably the insert core 40 has a longitudinal extending length, preferably longer than longitudinal extending length of the surrounding molded plastic forming the outward faces, preferably with insert core ends 300 extending and protruding out from the surrounding plastic and inclined surfaces ends 400. Preferably the first member inner mount assembly 30 including a first member inner mount molded second split 31, the first member inner mount molded second split 31 including a third inclined outwardly facing substantially planar outer perimeter molded surface 36 and a fourth inclined outwardly facing substantially planar outer perimeter molded surface 38. Preferably the third and fourth surfaces are upper and lower surfaces oriented relative to the mount vertical center axis plane 10, and intersect at a second mount midpoint 101 distal from the vertical center axis plane 10, and distal from an expander and the second split insert core 42. The first member inner mount molded second split 31, preferably includes second insert core 42 with expander receiving cavity 43, preferably with the mold core insert 42 inserted into a plastic injection mold with the third and fourth surfaces 36 and 38 molded to it, preferably a metal insert core 42 with the third and fourth surfaces 36 and 38 molded plastic surfaces, preferably with the insert core ends 300 protruding out beyond the plastic ends 400. Preferably the first member inner mount assembly 30 including an expander 70. The expander 70 inserted between the first member inner mount molded first split 29 and the first member inner mount molded second split 31 and received in the first insert core expander receiving cavity 41 and the second insert core expander receiving cavity 43. The expander 70 preferably having a uniform crossection relative to insert core longitudinal length, preferably an extruded metal expander 70 with the uniform crossection relative to the inclined surfaces. Preferably the outwardly facing surfaces are planar, and preferably are noncircular and noncurved. Preferably the inwardly facing surfaces are planar, and preferably are noncircular and noncurved. Preferably the mount includes a first elastomeric member 500, the first elastomeric member bonded between the first inclined inwardly facing surface and the first inclined outwardly facing surface, a second elastomeric member 502, the second elastomeric member 502 bonded between the second inclined inwardly facing surface and the second inclined outwardly facing surface, a third elastomeric member 504, the third elastomeric member 504 bonded between the third inclined inwardly facing surface and the third inclined outwardly facing surface, and a fourth elastomeric member 506, the fourth elastomeric member 506 bonded between the fourth inclined inwardly facing surface and the fourth inclined outwardly facing surface. Preferably the expander 70 includes a junction 71 for attachment with the first member, preferably with the expander junction 71 including a bolt hole or a protruding stud for fixturing with the first member to be isolated and supported from the second member. Preferably the first insert core 40 has a first mating concave circular surface 600 defining the first insert core expander receiving cavity 41 and the second insert core 42 has a second mating concave circular surface 601 defining the second insert core expander receiving cavity 43, with the expander 70 including a first corresponding matching convex circular mating surface 602 contacting the first insert core first mating concave surface and an opposing second corresponding matching convex circular mating surface 603 contacting the second insert core mating concave surface. Preferably the expander junction 71 is centered between the first and second convex mating surfaces. Preferably the expander 70 has a longitudinally extending length 700 with a first expander end 701 and a distal second expander end 702, preferably an upper end 701 and a lower end 702, preferably with the longitudinally extending length 700 in alignment with the mount vertical center axis plane 10. Preferably the expander longitudinally extending length 700 is aligned with a mount vertical center axis plane 10 and the first upper expander end 701 includes a first flange protrusion 710 and an opposing second flange protrusion 711, the first flange protrusion 710 and the second flange protrusion 711 protruding away from the mount vertical center axis plane 10. Preferably the second expander end 702 includes a third flange protrusion 710 and an opposing fourth flange protrusion 711. Preferably the first inclined outwardly facing surface and the third inclined outwardly facing surface converge towards the first upper expander end 701. Preferably the second inclined outwardly facing surface and the fourth inclined outwardly facing surface converge towards the second lower expander end 702. Preferably the expander longitudinally extending length 700 is aligned with a mount vertical center axis plane 10 and the first inclined outwardly facing surface and the second inclined outwardly facing surface converge towards a first mount midpoint 100 distal from the mount vertical center axis plane 10. Preferably the expander longitudinally extending length 700 is aligned with a mount vertical center axis plane 10 and the third inclined outwardly facing surface and the fourth inclined outwardly facing surface converge towards a second mount midpoint 101 distal from the mount vertical center axis plane 10 and distal and opposing the first mount midpoint 100 with the plane 10 centered between the mount midpoints 100 and 101. Preferably the expander longitudinally extending length 700 is aligned with a mount vertical center axis plane 10 and the first inclined outwardly facing surface and the second inclined outwardly facing surface converge towards a first mount midpoint 100 distal from the mount vertical center axis plane, and the third inclined outwardly facing surface and the fourth inclined outwardly facing surface converge towards opposing second mount midpoint 101 distal from the mount vertical center axis plane 10 with the vertical center axis plane centered between the first and second mount midpoints with the first and second mount midpoints defining a horizontal mount midpoint plane 11 preferably normal to the vertical center axis plane 10. Preferably the first elastomeric member 500 includes a first nonelastomeric shim 510 bonded in the elastomer and between the first inclined inwardly facing surface 22 and the first inclined outwardly facing surface 32, preferably with the planar shim 510 in alignment with the planar first inclined inwardly facing surface and the planar first inclined outwardly facing surface. Preferably the second elastomeric member 502 includes a second nonelastomeric shim 510 bonded in the elastomer and between the second inclined inwardly facing surface 24 and the second inclined outwardly facing surface 34, preferably with planar shim 510 in alignment with the planar second inclined inwardly facing surface 502 and the planar second inclined outwardly facing surface 34. Preferably the third elastomeric member 504 includes a third nonelastomeric shim 510 bonded in the elastomer and between the third inclined inwardly facing surface 26 and the third inclined outwardly facing surface 36, preferably with the planar shim 510 in alignment with the planar third inclined inwardly facing surface 26 and the planar third inclined outwardly facing surface 36. Preferably the fourth elastomeric member 506 includes a fourth nonelastomeric shim 510 bonded in the elastomer and between the fourth inclined inwardly facing surface 28 and the fourth inclined outwardly facing surface 38, preferably with the planar shim 510 in alignment with the planar fourth inclined inwardly facing surface and the planar fourth inclined outwardly facing surface. Preferably the first elastomeric member includes a first nonelastomeric shim 510, the second elastomeric member includes a second nonelastomeric shim 510, the third elastomeric member includes a third nonelastomeric shim 510, and the fourth elastomeric member includes a fourth nonelastomeric shim 510, preferably with the nonelastomeric shims substantially planar and bonded in the elastomer between and in parallel alignment with the inclined inwardly facing surfaces and the inclined outwardly facing surfaces. Preferably second member outer mount housing 20 is nonextensible and formed from a metal, preferably with the inner mount molded split members outwardly facing planer surfaces nonextensible and formed from molded plastic with the inner mount molded split member plastic molded partially around the metal insert cores 40, 42, which preferably are nonextensible structures, preferably metal tubular shell segments, preferably a tube half. Preferably the split members are formed with molded glass filled plastic between the metal insert core tube halves and the upper and lower outwardly facing planer surfaces with the mold insert core inserted into a plastic injection mold with glass filled plastic then injection molded to the insert core. Preferably the elastomer is bonded to the mold bonded plastic outwardly facing substantially planer surfaces of the splits, and planar nonextensible shims 510 preferably formed from a metal, with the elastomer bonded to the metal shims inner and outer facing planar surfaces, and with the elastomer bonded to the second member outer mount housing metal inwardly facing planar surfaces. Preferably the expander 70 is inserted after the elastomers are assembled to and bonded to the inwardly and outwardly bonded planar surfaces of the inner member 30 and the outer member 20. Preferably the second member outer housing first inclined inwardly facing surface is planar. Preferably the second member outer housing second inclined inwardly facing surface is planar. Preferably the second member outer housing third inclined inwardly facing surface is planar. Preferably the second member outer housing fourth inclined inwardly facing surface is planar. In an alternative embodiment the second member outer housing first inclined inwardly facing surface is nonplanar. In an alternative embodiment the second member outer housing second inclined inwardly facing surface is nonplanar. In an alternative embodiment the second member outer housing third inclined inwardly facing surface is nonplanar. In an alternative embodiment the second member outer housing fourth inclined inwardly facing surface is nonplanar. Preferably the first member first inclined outwardly facing surface is planar. Preferably the first member second inclined outwardly facing surface is planar. Preferably the first member third inclined outwardly facing surface is planar. Preferably the first member outer fourth inclined outwardly facing surface is planar. In an alternative embodiment the first inclined outwardly facing surface is nonplanar. In an alternative embodiment the second inclined outwardly facing surface is nonplanar. In an alternative embodiment the third inclined outwardly facing surface is nonplanar. In an alternative embodiment the fourth inclined outwardly facing surface is nonplanar. In an embodiment the second member outer housing first inclined inwardly facing surface is comprised of a nonelastomeric nonextensible foot, preferably a plastic or metal foot shim which is fixed to the outer housing structure. In an embodiment the second member outer housing second inclined inwardly facing surface is comprised of a nonelastomeric nonextensible foot. In an embodiment the second member outer housing third inclined inwardly facing surface includes a nonelastomeric nonextensible foot. In an embodiment the second member outer housing fourth inclined inwardly facing surface includes a nonelastomeric nonextensible foot. Preferably the first upper expander end 701 includes a first flange protrusion 710 and an opposing second flange protrusion 711 and an upper contact snubber end surface 750, preferably a planar contact surface. In an alternative embodiment the contact snubber end surface 750 is a nonplanar contact surface preferably with a central peak protrusion 760, preferably with the peak 760 aligned with the central vertical axis 10. Preferably the second lower opposing expander end includes a third flange protrusion and an opposing fourth flange protrusion and a lower contact snubber end surface 751, preferably a planar contact surface. In an alternative embodiment the contact end surface 751 is a nonplanar contact surface preferably with a central peak protrusion 760, preferably with the peak 760 aligned with central vertical axis 10. Preferably the invention includes mounts and methods of making mounts and a system of making mounts with a plurality of expanders 70, preferably with at least first, second, and third expanders 70, with variation in at least one predetermined expander feature dimension, preferably chosen from and including variation in expander end contact longitudinal axis thickness, variation in contact snubber thickness in direction away from center, variation contact snubber surface crossectional shape including planar and nonplanar, peak heights and inclined angles and curvature, and variation in expander thickness oriented with the vertical axis plane 10.

It will be apparent to those skilled in the art that various modifications and variations can be made to the invention without departing from the spirit and scope of the invention. Thus, it is intended that the invention cover the modifications and variations of this invention provided they come within the scope of the appended claims and their equivalents. It is intended that the scope of differing terms or phrases in the claims may be fulfilled by the same or different structure(s) or step(s).

That which is claimed is:

1. A cab suspension mount for supporting and isolating a first member from a second member, comprising: a second member outer mount housing, said second member outer housing for attachment with said second member, said second member outer housing having a first inclined inwardly facing surface, a second inclined inwardly facing surface, a third inclined inwardly facing surface, a fourth inclined inwardly facing surface,
a first member inner mount assembly, said first member inner mount assembly including a first member inner mount molded first split, said first member inner mount molded first split including a first inclined outwardly facing surface and a second inclined outwardly facing surface, and a first insert core with an expander receiving cavity, said first member inner mount assembly including a first member inner mount molded second split, said first member inner mount molded second split including a third inclined outwardly facing surface and a fourth inclined outwardly facing surface, and a second insert core with an expander receiving cavity said first member inner mount assembly including an expander, said expander inserted between said first member inner mount molded first split and said first member inner mount molded second split and received in said first insert core expander receiving cavity and said second insert core expander receiving cavity,
a first elastomeric member, said first elastomeric member bonded between said first inclined inwardly facing surface and said first inclined outwardly facing surface,
a second elastomeric member, said second elastomeric member bonded between said second inclined inwardly facing surface and said second inclined outwardly facing surface,
a third elastomeric member, said third elastomeric member bonded between said third inclined inwardly facing surface and said third inclined outwardly facing surface,
a fourth elastomeric member, said fourth elastomeric member bonded between said fourth inclined inwardly facing surface and said fourth inclined outwardly facing surface.

2. A mount as claimed in claim 1, wherein said expander includes a junction for attachment with said first member.

3. A mount as claimed in claim 1, wherein said first insert core has a first mating surface defining said first insert core expander receiving cavity and said second insert core has a second mating surface defining said second insert core expander receiving cavity, said expander includes a first corresponding mating surface contacting said first insert core first mating surface and a second corresponding mating surface contacting said second insert core mating surface.

4. A mount as claimed in claim 1, wherein said expander has a longitudinally extending length with a first expander end and a distal second expander end

5. A mount as claimed in claim 4, wherein said expander longitudinally extending length is aligned with a mount vertical center axis plane and said first expander end includes a first flange protrusion and a second flange protrusion, said first flange protrusion and said second flange protrusion protruding away from said mount vertical center axis plane.

6. A mount as claimed in claim 4, wherein said first inclined outwardly facing surface and said third inclined outwardly facing surface converge towards said first expander end.

7. A mount as claimed in claim 4, wherein said second inclined outwardly facing surface and said fourth inclined outwardly facing surface converge towards said second expander end.

8. A mount as claimed in claim 4, wherein said expander longitudinally extending length is aligned with a mount vertical center axis plane and said first inclined outwardly facing surface and said second inclined outwardly facing surface converge towards a first mount midpoint distal from said mount vertical center axis plane.

9. A mount as claimed in claim 4, wherein said expander longitudinally extending length is aligned with a mount vertical center axis plane and said third inclined outwardly facing surface and said fourth inclined outwardly facing surface converge towards a second mount midpoint distal from said mount vertical center axis plane.

10. A mount as claimed in claim 4, wherein said expander longitudinally extending length is aligned with a mount vertical center axis plane and said first inclined outwardly facing surface and said second inclined outwardly facing surface converge towards a first mount midpoint distal from said mount vertical center axis plane, and said third inclined outwardly facing surface and said fourth inclined outwardly facing surface converge towards a second mount midpoint distal from said mount vertical center axis plane

11. A mount as claimed in claim 1, wherein said first elastomeric member includes a first nonelastomeric shim.

12. A mount as claimed in claim 1, wherein said second elastomeric member includes a second nonelastomeric shim.

13. A mount as claimed in claim 1, wherein said third elastomeric member includes a third nonelastomeric shim.

14. A mount as claimed in claim 1, wherein said fourth elastomeric member includes a fourth nonelastomeric shim.

15. A mount as claimed in claim 1, wherein said first elastomeric member includes a first nonelastomeric shim, said second elastomeric member includes a second nonelastomeric shim, said third elastomeric member includes a third nonelastomeric shim, said fourth elastomeric member includes a fourth nonelastomeric shim.

16. A mount as claimed in claim 1, wherein said second member outer housing first inclined inwardly facing surface is planar.

17. A mount as claimed in claim 1, wherein said second member outer housing second inclined inwardly facing surface is planar.

18. A mount as claimed in claim 1, wherein said second member outer housing third inclined inwardly facing surface is planar.

19. A mount as claimed in claim 1, wherein said second member outer housing fourth inclined inwardly facing surface is planar.

20. A mount as claimed in claim 1, wherein said first member first inclined outwardly facing surface is planar.

21. A mount as claimed in claim 1, wherein said first member second inclined outwardly facing surface is planar.

22. A mount as claimed in claim 1, wherein said first member third inclined outwardly facing surface is planar.

23. A mount as claimed in claim 1, wherein said first member outer fourth inclined outwardly facing surface is planar.

24. A mount as claimed in claim 1, wherein said second member outer housing first inclined inwardly facing surface is comprised of a nonelastomeric foot.

25. A mount as claimed in claim 1, wherein said second member outer housing second inclined inwardly facing surface is comprised of a nonelastomeric foot.

26. A mount as claimed in claim 1, wherein said second member outer housing third inclined inwardly facing surface is comprised of a nonelastomeric foot.

27. A mount as claimed in claim 1, wherein said second member outer housing fourth inclined inwardly facing surface is comprised of a nonelastomeric foot.

28. A mount as claimed in claim 4, wherein said first expander end includes a first flange protrusion and a second flange protrusion and an upper end surface.

29. A mount as claimed in claim 4, wherein said second expander end includes a third flange protrusion and a fourth flange protrusion and a lower end surface.

30. A mount as claimed in claim 4, wherein said second member outer housing fourth inclined inwardly facing surface is comprised of a foot.

31. A mount for supporting and isolating a first member from a second member, comprising:
a second member outer housing, said second member outer housing for attachment with said second member, a first member inner mount assembly, said first member inner mount assembly including an at least first member inner mount molded first split, said first member inner mount molded first split including an at least first inclined outwardly facing surface and a first insert core with an expander receiving cavity, said first member inner mount assembly including a first member inner mount molded at least second split, said first member inner mount molded at least second split including a second split inclined outwardly facing surface and a second insert core with an expander receiving cavity, said first member inner mount assembly including an expander, said expander inserted between said first member inner mount molded first split and said first member inner mount molded second split and received in said first insert core expander receiving cavity and said second insert core expander receiving cavity, an at least first elastomeric member, said first elastomeric member bonded to said first inclined outwardly facing surface, and an at least a second split elastomeric member, said second split elastomeric member bonded to said second split inclined outwardly facing surface.

32. A mount as claimed in claim 31, wherein said expander includes a junction for attachment with said second member.

33. A mount as claimed in claim 31, wherein said first insert core has a first mating surface defining said first insert core expander receiving cavity and said second insert core has a second mating surface defining said second insert core expander receiving cavity, said expander includes a first corresponding mating surface contacting said first insert core first mating surface and a second corresponding mating surface contacting said second insert core mating surface.

34. A mount as claimed in claim 31, wherein said expander has a longitudinally extending length with a first expander end and a distal second expander end.

35. A mount as claimed in claim 34, wherein said expander longitudinally extending length is aligned with a mount vertical center axis plane and said first expander end includes a first flange protrusion and a second flange protrusion, said first flange protrusion and said second flange protrusion protruding away from said mount vertical center axis plane.

36. A mount as claimed in claim 34, wherein said expander longitudinally extending length is aligned with a mount vertical center axis plane and said first inclined outwardly facing surface extends towards a first mount midpoint distal from said mount vertical center axis plane.

37. A mount as claimed in claim 31, wherein said first elastomeric member includes a first nonelastomeric shim.

38. A mount as claimed in claim 31, wherein said elastomeric members include a nonelastomeric shim.

39. A mount as claimed in claim 31, wherein said second member outer housing has a first inclined inwardly facing surface.

40. A mount as claimed in claim 39, wherein said second member outer housing first inclined inwardly facing surface is planar.

41. A mount as claimed in claim 31, wherein said second member outer housing has a third inclined inwardly facing planar surface.

42. A mount as claimed in claim 31, wherein said first member first inclined outwardly facing surface is planar.

43. A mount as claimed in claim 31, wherein said first member second inclined outwardly facing surface is planar.

44. A mount as claimed in claim 31, wherein said first member third inclined outwardly facing surface is planar.

45. A mount as claimed in claim 31, wherein said second member outer housing first inclined inwardly facing surface is comprised of a nonelastomeric foot.

46. A mount as claimed in claim 34, wherein said first expander end includes a first flange protrusion and a second flange protrusion and an upper end surface.

47. A mount as claimed in claim 34, wherein said second expander end includes a third flange protrusion and a fourth flange protrusion and a lower end surface.

48. A method of making a mount for supporting and isolating a first member from a second member, comprising:
providing a second member outer housing, said second member outer housing for attachment with said second member, providing a first member inner mount assembly, said first member inner mount assembly including an at least first member inner mount first split, said first member inner mount first split including an at least first inclined outwardly facing surface, and a first insert core with an expander receiving cavity, said first member inner mount assembly including a first member inner mount at least second split, said first member inner mount at least second split including a second split inclined outwardly facing surface and a second insert core with an expander receiving cavity, providing a first member inner mount assembly expander, inserting said expander between said first member inner mount first split and said first member inner mount second split with said expander received in said first insert core expander receiving cavity and said second insert core expander receiving cavity.

49. A method as claimed in claim 48 wherein providing a first member inner mount assembly includes molding said at least first inclined outwardly facing surface to said first insert core.

50. A method as claimed in claim 48 including providing at least a first expander with a first predetermined expander dimensional feature and providing a second expander with a second predetermined expander dimensional feature.
